(19) United States
(12) Patent Application Publication
(10) Pub. No.: US 2025/0168692 A1
(43) Pub. Date: May 22, 2025

(54) MULTI-LINK ADAPTATION BASED ON NETWORK QUALITY MONITORING

(71) Applicant: Samsung Electronics Co., Ltd., Suwon-si (KR)

(72) Inventors: Neha Dawar, McKinney, TX (US); Abhishek Sehgal, Frisco, TX (US); Kyeong Jin Kim, Plano, TX (US); Yuming Zhu, Plano, TX (US); Yirong Cheng, Houston, TX (US)

(21) Appl. No.: 18/934,129

(22) Filed: Oct. 31, 2024

Related U.S. Application Data
(60) Provisional application No. 63/599,869, filed on Nov. 16, 2023.

(51) Int. Cl. H04W 28/02; H04N 7/14; H04W 80/04

(52) U.S. Cl. CPC H04W 28/0268; H04N 7/147; H04W 80/04

(57) ABSTRACT

An electronic device includes a transceiver configured to adapt between single-link operation (SLO) and multi-link (MLO) operation, and a processor operably coupled to the transceiver. The processor is configured to determine a quality of service (QOS) of a video call for a number of time steps, and determine, based on the QoS of the video call over the number of time steps, whether to adjust a number of links utilized by the transceiver. The processor is further configured to, in response to a determination to adjust the number of links, adjust the number of links utilized by the transceiver.

### CROSS-REFERENCE TO RELATED APPLICATION(S) AND CLAIM OF PRIORITY

This application claims priority under 35 U.S.C. § 119 (e) to U.S. Provisional Patent Application No. 63/599,869 filed on Nov. 16, 2023. The above-identified provisional patent application is hereby incorporated by reference in its entirety.

### TECHNICAL FIELD

This disclosure relates generally to wireless networks. More specifically, this disclosure relates to multi-link adaptation based on network quality monitoring.

### BACKGROUND

WiFi-7 (IEEE802.11be) is the latest amendment of the IEEE 802.11 protocol that focuses on providing WLAN services with higher capacity and better reliability. Compared to previous versions of WiFi, WiFi-7 provides several features to enhance its performance, including: (1) Multi-link Operation (MLO) among channels over 2.4 GHz, 5 GHZ, and 6 GHZ, (2) 320 MHz bandwidth and more efficient spectrum utilization over 6 GHz, and (3) spatial streams and MIMO protocol enhancement. The MLO feature can improve network capacity and reliability by providing extra channel resources.

### SUMMARY

This disclosure provides apparatuses and methods for multi-link adaptation based on network quality monitoring.

In one embodiment, an electronic device is provided. The electronic device includes a transceiver configured to adapt between single-link operation (SLO) and multi-link (MLO) operation, and a processor operably coupled to the transceiver. The processor is configured to determine a quality of service (QOS) of a video call for a number of time steps, and determine, based on the QoS of the video call over the number of time steps, whether to adjust a number of links utilized by the transceiver. The processor is further configured to, in response to a determination to adjust the number of links, adjust the number of links utilized by the transceiver.

In another embodiment, a method of operating an electronic device is provided. The method includes determining a QoS of a video call for a number of time steps, and determining, based on the QoS of the video call over the number of time steps, whether to adjust a number of links utilized by a transceiver configured to adapt between SLO and multi-link MLO operation. The method further includes, in response to a determination to adjust the number of links, adjusting the number of links utilized by the transceiver.

In yet another embodiment, a non-transitory computer readable medium embodying a computer program is provided. The computer program includes program code that, when executed by a processor of a device, causes the device to determine a QoS of a video call for a number of time steps, and determine, based on the QoS of the video call over the number of time steps, whether to adjust a number of links utilized by a transceiver configured to adapt between SLO and MLO operation. The computer program also includes program code that, when executed by the processor of the device, causes the device to, in response to a determination to adjust the number of links, adjust the number of links utilized by the transceiver.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The following documents and standards descriptions are hereby incorporated into the present disclosure as if fully set forth herein: [1] IEEE 802.11-2020, “Wireless LAN Medium Access Control (MAC) and Physical Layer (PHY) Specification”; and [2] IEEE P802.11be/D1.01.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example access point according to various embodiments of the present disclosure;

FIG. 2B illustrates an example station according to various embodiments of this disclosure;

FIG. 3 illustrates an example wireless network with an access point-multi-link device and a non-access point-multi-link device according to various embodiments of this disclosure;

FIGS. 4A-4B illustrate an example method for quality classification using MAC-layer features according to embodiments of the present disclosure;

FIG. 5 illustrates an example method for decision tree classification using MAC-layer features according to embodiments of the present disclosure;

FIGS. 6A-6B illustrate an example method for quality classification using both MAC-layer features and IP layer features according to embodiments of the present disclosure;

FIG. 7 illustrates an example method for collecting MAC-layer features and IP-layer features according to embodiments of the present disclosure;

FIG. 8 illustrates an example decision tree for quality classification according to embodiments of the present disclosure;

FIG. 9 illustrates an example state machine to add/remove links based on quality classification according to embodiments of the present disclosure;

FIG. 10 illustrates another example state machine to add/remove links based on quality classification according to embodiments of the present disclosure;

FIG. 11 illustrates another example decision tree for quality classification according to embodiments of the present disclosure;

FIG. 12 illustrates an example state machine to add/remove links based on score-based quality classification according to embodiments of the present disclosure;

FIG. 13 illustrates an example method for hysteresis thresholding based dynamic MLO adaptation according to embodiments of the present disclosure; and

FIG. 14 illustrates an example method for multi-link adaptation based on network quality monitoring according to embodiments of the present disclosure.

### DETAILED DESCRIPTION

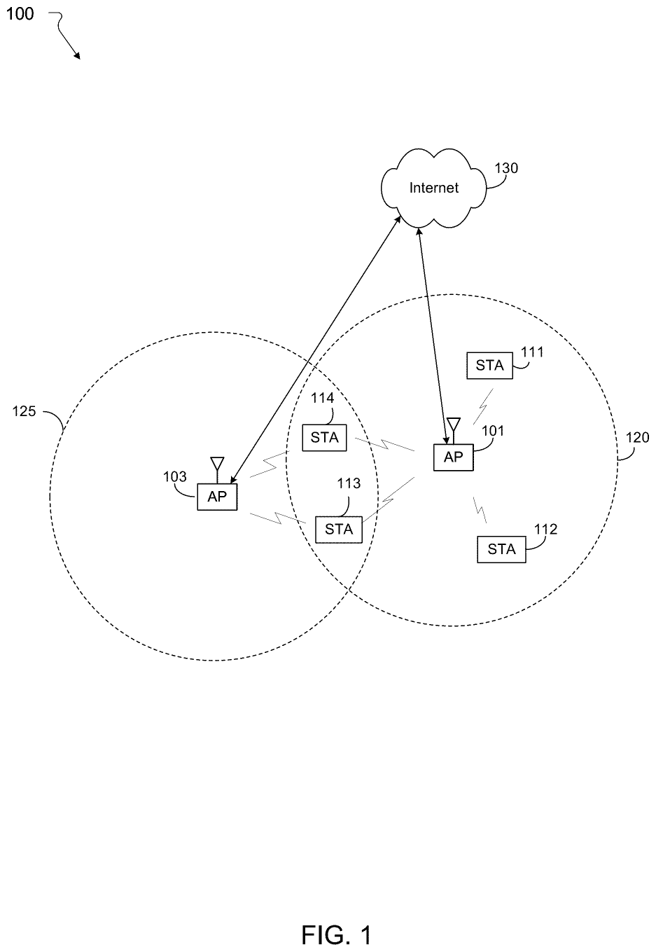

FIGS. 1 through 14, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

IEEE 802.11be [2] supports multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

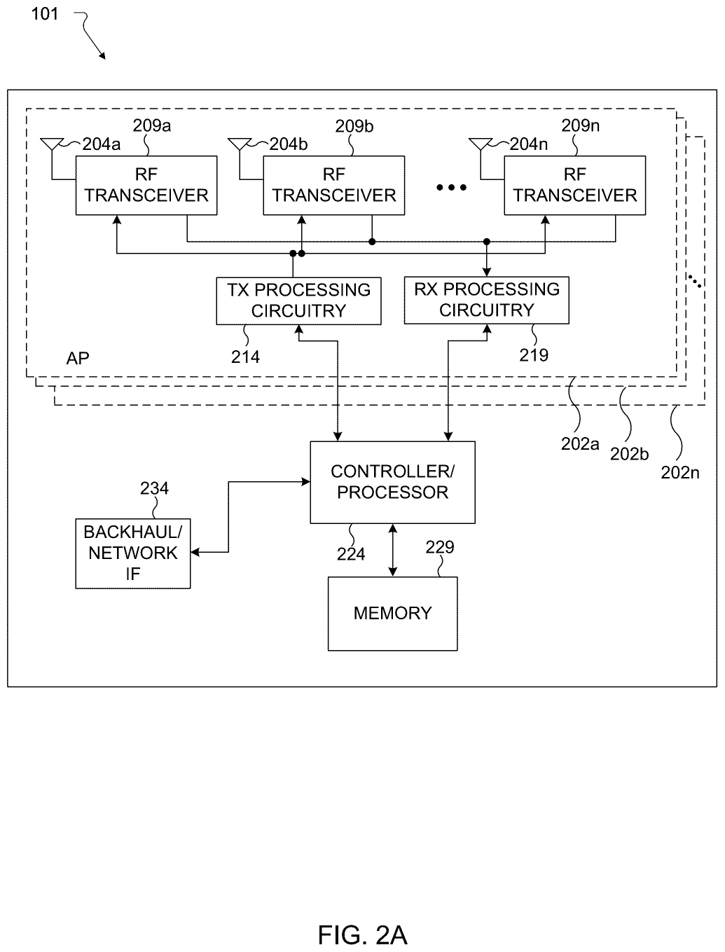

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

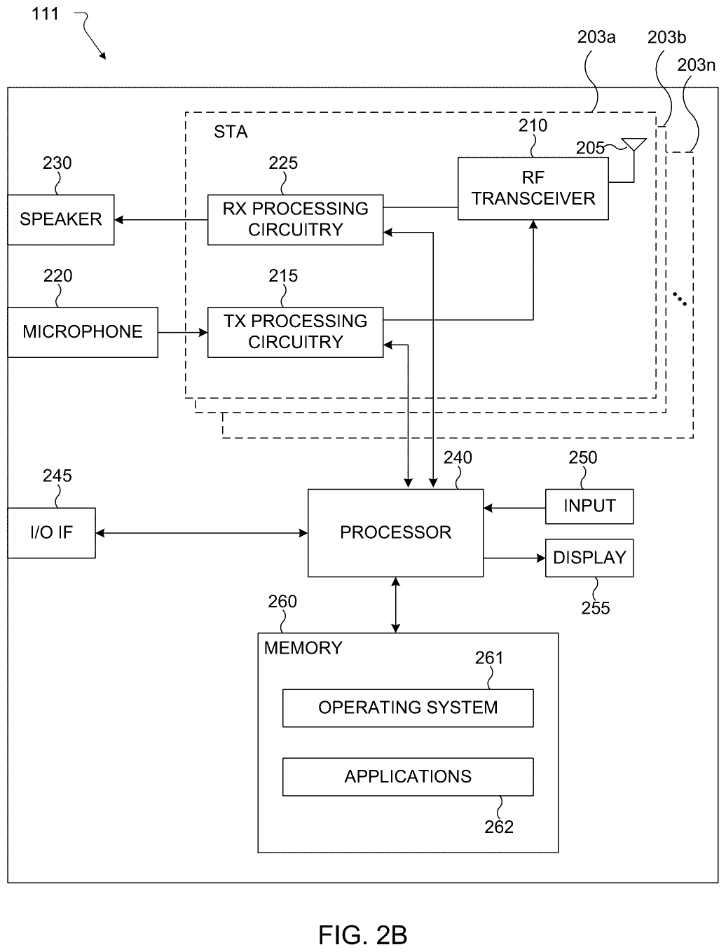

FIG. 3 illustrates an example wireless network 300 with an AP MLD and a non-AP MLD according to various embodiments of this disclosure. The embodiment of the system in FIG. 3 is for illustration only. Other embodiments of a wireless communication system could be used without departing from the scope of this disclosure.

In the example of FIG. 3 a non-AP MLD 302 is illustrated operating on N links 306, and AP MLD 304 that has a multi-link association with the non-AP MLD on the N links 306. The N links 306 may be represented as N={1, 2, . . . , N}.

Although FIG. 3 illustrates one example of a wireless network with an AP MLD and a non-AP MLD device, various changes may be made to FIG. 3. For example, the number of AP MLD devices may change, the number of non-AP MLD devices may change, etc.

WiFi-7 includes features to reduce communication latency and improve the network throughput by enabling an asynchronous and simultaneous MAC and PHY layer operation in separate channels/links. However, activating multiple links at the same time will also incur more power consumption for WiFi-7 and reduce the battery life of the WiFi-7 devices. To lessen the effect of these issues, the present disclosure provides various embodiments that include dynamic adaptation of multi-link operation (MLO) configurations. For example, some embodiments include a control algorithm that dynamically adapt between single-link operation (SLO) and MLO to balance the trade-off between power consumption and network performance while preserving the device application's quality of service (QOS). In some embodiments, the application QOS is predicted to determine whether to add or remove a link, or maintain a current link configuration.

In some embodiments, the application QoS can be predicted based on the quality of a video call. If the quality of the video call is “good” while using the current link configuration, the call can continue using the same link configuration without expecting poor QoS. In some embodiments, if the quality of video call is good, a link can be dropped to save power. In some embodiments, if the quality of the video call degrades, which means either the frame rate drops, or the resolution of frames drop or if jitter is experienced in the call, another link can be added to improve the QoS of the video call.

In some embodiments, medium access control (MAC)-layer features may be used to classify a video call quality as being “good” or “bad.”

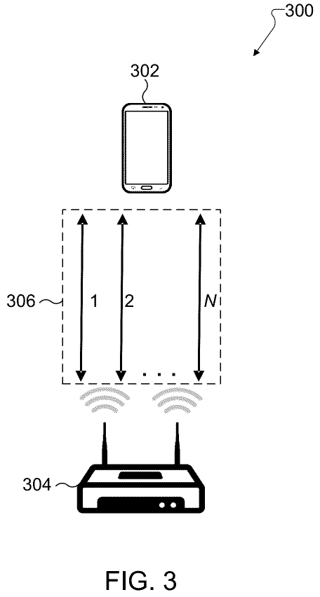

FIGS. 4A-4B illustrate an example method for quality classification using MAC-layer features 400 according to embodiments of the present disclosure. An embodiment of the method illustrated in FIGS. 4A-4B is for illustration only. One or more of the components illustrated in FIGS. 4A-4B may be implemented in specialized circuitry configured to perform the noted functions or one or more of the components may be implemented by one or more processors executing instructions to perform the noted functions. Other embodiments of a method for quality classification using MAC-layer features could be used without departing from the scope of this disclosure.

In the example of FIGS. 4A-4B, a machine learning classifier 420 is used with MAC-layer features 410 to classify the quality of calls as good or bad. In some embodiments, the MAC-layer features include one or more of: (1) the portion of time the link stays in different link state (Tx/Rx/CCA_busy/Idle), (2) the transmission success rate, (3) the interframe space durations (e.g., DIFS, SIFS), and (4) the PHY rate.

At link decision 440, whenever the quality of calls is classified as bad, the application quickly adds another link to preserve the QoS. However, when the quality of calls is classified as good, the application takes time to ensure persistent good quality before dropping a link. In some embodiments, as shown in FIG. 4B, a state machine 430 can be used after classifier 420, to provide a fast attack (e.g., in the case of adding a link) and slow release strategy (e.g., in the case of dropping a link) for respectively enabling/disabling links depending on the quality of calls obtained from classifier 420.

Although FIGS. 4A-4B illustrate one example method for quality classification using MAC-layer features 400, various changes may be made to FIGS. 4A-4B. For example, while shown as a series of steps, various steps in FIGS. 4A-4B could overlap, occur in parallel, occur in a different order, occur any number of times, be omitted, or replaced by other steps.

In some embodiments, classification of call quality (e.g., by classifier 420) may be performed using a decision tree classifier.

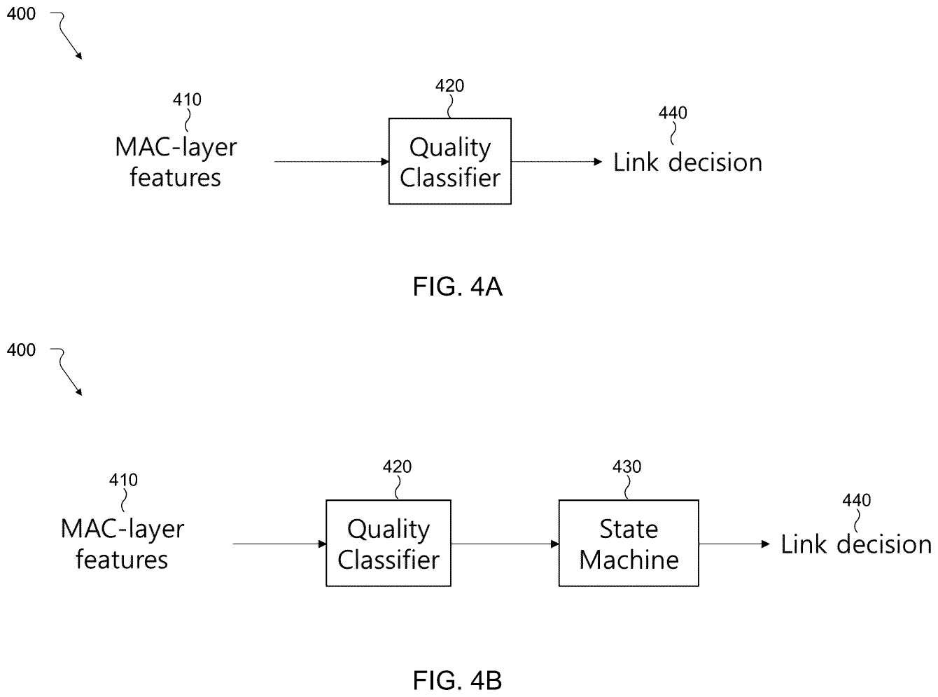

FIG. 5 illustrates an example method for decision tree classification using MAC-layer features 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a method for decision tree classification using MAC-layer features could be used without departing from the scope of this disclosure.

In the Example of FIG. 5, the classification of call quality is performed using a decision tree classifier using the MAC-layer features phy_rate, successᵣₐₜₑ, and T_{cca}/Tᵣₒ for classification.

Phy_rate refers to the data rate when all channel resource are being utilized. the phy_rate is determined by the channel bandwidth and the modulation coding scheme (MCS) used for the link. The phy_rate is expected to be high in a good quality call.

Success_rate refers to the ratio of successful transmissions to the total transmissions. The success_rate is expected to be high when the call quality is good.

T_{cca}/Tᵣₒ refers the ratio of time the link is in clear channel assessment (CCA)_BUSY over the time the link radio is on. CCA is a method of finding if any other RF transmissions are occupying the channel. CCA uses two different thresholds to listen to the RF medium-a signal detect (SD) threshold, and an energy detect (ED) threshold. The SD threshold is used to detect any other WiFi transmissions, while the ED threshold is used to detect any other type of RF transmissions during CCA. CCA BUSY refers to the time the PHY indicates to the MAC that the channel is occupied by another (WiFi or other RF) transmission. The ratio T_{cca}/Tᵣₒ is expected to be low in a good-quality call.

In the Example of FIG. 5, the classification begins at step 510. At step 510, if the if phy_rate in Mbps is equal to or above a certain threshold Thpr (e.g., Thor=100), the method proceeds to step 520. Otherwise, if phy_rate is below the threshold Thor, the classifier outputs the quality as bad.

At step 520, if success_rate is equal to or above a threshold Thsr (e.g., Thsr=0.5), the method proceeds to step 530. Otherwise, if success_rate is below the threshold Thsr, the classifier outputs the quality as bad.

At step 530, if T_{cca}/Tᵣₒ is equal to or below a certain threshold Ther (e.g., Ther=0.55), the classifier outputs the quality as good. Otherwise, if T_{cca}/Tᵣₒ is above the threshold Ther, the classifier outputs the quality as bad.

Although FIG. 5 illustrates one example method for decision tree classification using MAC-layer features 500, various changes may be made to FIG. 5. For example, while shown as a series of steps, various steps in FIG. 5 could overlap, occur in parallel, occur in a different order, occur any number of times, be omitted, or replaced by other steps. In another example, more link features and another classifier could be used to perform quality classification.

In some embodiments, both MAC-layer features and internet protocol (IP)-layer features may be used to classify a video call quality as being “good” or “bad.”

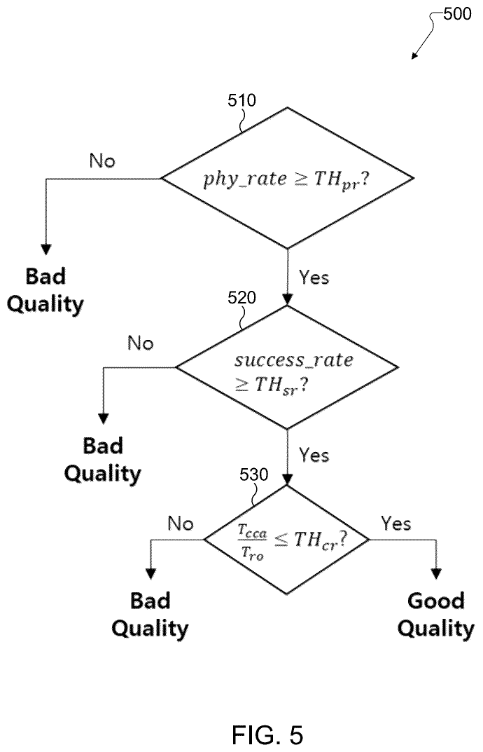

FIGS. 6A-6B illustrate an example method for quality classification using both MAC-layer features and IP layer features 600 according to embodiments of the present disclosure. An embodiment of the method illustrated in FIGS. 6A-6B is for illustration only. One or more of the components illustrated in FIGS. 6A-6B may be implemented in specialized circuitry configured to perform the noted functions or one or more of the components may be implemented by one or more processors executing instructions to perform the noted functions. Other embodiments of a method for quality classification using MAC-layer features could be used without departing from the scope of this disclosure.

In the example of FIGS. 6A-6B, a machine learning classifier 630 is used with MAC-layer features 610 and IP-layer features 620 to classify the quality of calls as good or bad. In some embodiments, the MAC-layer features include one or more of: (1) the portion of time the link stays in different link state (Tx/Rx/CCA_busy/Idle), (2) the transmission success rate, (3) the interframe space durations (e.g., DIFS, SIFS), and (4) the PHY rate.

At link decision 650, whenever the quality of calls is classified as bad, the application quickly adds another link to preserve the QoS. However, when the quality of calls is classified as good, the application takes time to ensure persistent good quality before dropping a link. In some embodiments, as shown in FIG. 6B, a state machine 640 can be used after classifier 630, to provide a fast attack (e.g., in the case of adding a link) and slow release strategy (e.g., in the case of dropping a link) for respectively enabling/disabling links depending on the quality of calls obtained from classifier 630.

Although FIGS. 6A-6B illustrate one example method for quality classification using both MAC-layer features and IP layer features 600, various changes may be made to FIGS. 6A-6B. For example, while shown as a series of steps, various steps in FIGS. 6A-6B could overlap, occur in parallel, occur in a different order, occur any number of times, be omitted, or replaced by other steps.

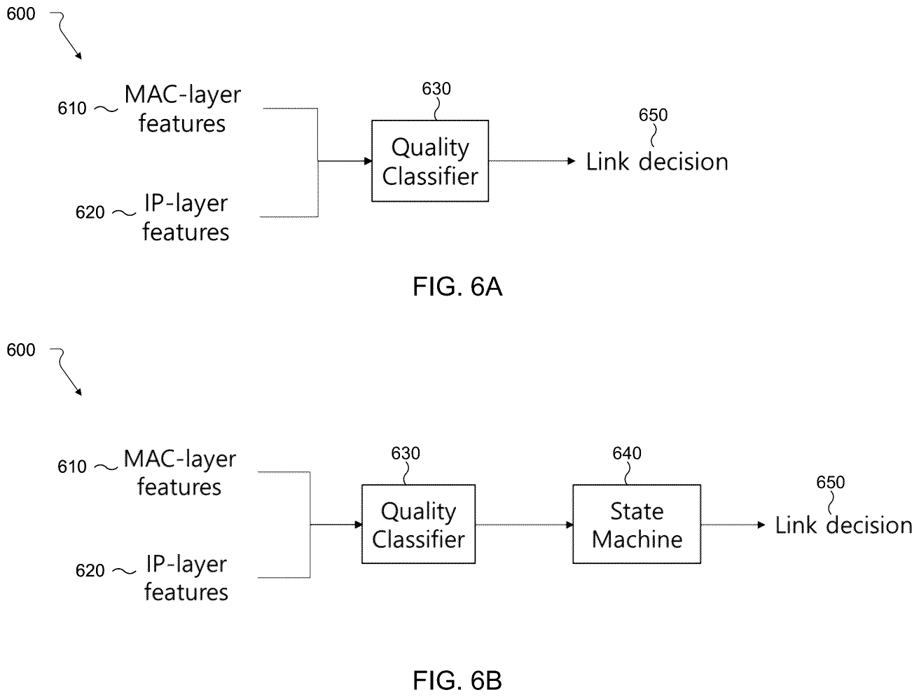

As described above, regarding FIGS. 6A-6B, the MAC-layer features 610 and IP-layer features 620 may imply the channel condition and can be used to estimate the Maximum Achievable Rate (MAR) of the device's application over each link as shown in FIG. 7. Similarly, The IP-layer features can be used to compute the actual throughput of the device's application over each link as shown in FIG. 7. The MAR and throughput may then be utilized by the classifier (e.g., classifier 630) to perform a quality classification. In some embodiments, the IP-layer features include one or more of: (1) transmitted/received bytes, and (2) payload size.

FIG. 7 illustrates an example method for collecting MAC-layer features and IP-layer features 700 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a method for collecting MAC-layer features and IP-layer features could be used without departing from the scope of this disclosure.

In the example of FIG. 7, a device such as non-AP MLD 302 of FIG. 3 includes a first timer for MAC-layer features, and a second timer for IP-layer features. The method begins with two separate branches that run concurrently. The first branch begins at step 705, and the second branch begins at step 725.

At step 705, the device resets the first timer (i.e., the MAC-layer timer).

At step 710, the device checks whether the MAC-layer timer has elapsed. If the MAC-layer timer has elapsed the first branch proceeds to step 715. Otherwise, if the MAC-layer timer has not elapsed, the first branch returns to step 710.

At step 715, the device obtains MAC-layer features for each link of the device (e.g., each of links 306 1 through N of FIG. 3). The MAC-layer features may include the portion of time the link stays in different link state (Tx/Rx/CCA_busy/Idle), the transmission success rate, the interframe space durations (e.g., DIFS, SIFS), and the PHY rate. The device then updates the MAR at step 735, and the first branch returns to step 705.

At step 720, the device resets the second time (i.e., the IP-layer timer).

At step 725, the device checks whether the IP-layer timer has elapsed. If the IP-layer timer has elapsed the second branch proceeds to step 730. Otherwise, if the IP-layer timer has not elapsed, the second branch returns to step 725.

At step 730, the device obtains IP-layer features for each link of the device (e.g., each of links 306 1 through N of FIG. 3). The IP layer features may include transmitted/received bytes and the Payload size. The IP layer features may be used when the device updates the MAR at step 735.

At step 735, the device updates the estimated MAR of the device's application over each link based on the MAC-layer features obtained in step 715, as well as IP-layer features obtained at step 730. The estimated MAR value is updated every MAC-layer timer cycle. In some embodiments, the MAR for the application may be estimated as follows:

For each link i within the past MAC-layer timer cycle,

$$MAR ( i ) = phy\_rate \times ( 1 - \frac{{T}_{c c a}}{{T}_{r o}} ) \times ( \frac{( 1 - p ) {T}_{s}}{( 1 - p ) {T}_{s} + p \cdot {T}_{c}} ) \times ( \frac{payload\_bits}{p h {y}_{-} rate \cdot {T}_{s}} )$$

where:

$${T}_{s} = {T}_{h e a d e r} + \frac{payload\_bits}{phy\_rate} + {T}_{SIFS} + {T}_{A C K} \\ {T}_{c} = {T}_{h e a d e r} + \frac{payload\_bits}{phy\_rate} + {T}_{AIFS} \\ p = \frac{TX\_retries}{TX\_attempts} = 1 - s uccess\_rate$$

Similar as described regarding, FIG. 5:

Phy_rate refers to the data rate when all channel resource are being utilized. The actual MAR is always lower than the phy_rate. The phy rate is determined by the channel bandwidth and the modulation coding scheme (MCS) used for the link. The phy rate is expected to be high in a good quality call.

Success_rate refers to the ratio of successful transmissions to the total transmissions. The success_rate is expected to be high when the call quality is good.

T_{cca}/Tᵣₒ refers the ratio of time the link is in clear channel assessment (CCA)_BUSY over the time the link radio is on. CCA is a method of finding if any other RF transmissions are occupying the channel. This ratio in the second term above refers to the portion of time the target link is under interference, only the portion of time with no interference that contributes to the throughput is considered. The ratio T_{cca}/Tᵣₒ is expected to be low in a good-quality call.

Tₛ and T_{c} refer to the time needed for a single transmission that is successful/failed due to collision. Both oTₛ and T_{c} consider not only the payload transmission time but also the control overhead (e.g., headers, interframe spacing, Acks). p is the collision probability at MAC layer and can be computed via the empirical re-transmission rate or success rate. The third term in the product form above eliminates the time spent in failed transmission due to collision, and only considers the portion of time when the channel resource is utilized for a successful transmission for MAR. The fourth term above further eliminates the time spent in control overhead of a successful transmission, as only the payload contributes to the throughput.

Concurrent with step 735, at step 740, the device computes the throughput of the device's application over each link based on the IP layer features obtained in step 730. The throughput is updated every IP-layer timer cycle.

At step 745, the MAR and the throughput are directly aggregated among the multiple links to get the total MAR and throughput for the application traffic. Every time the application throughput is updated, the device computes a Resource Utilization (RU) rate.

At step 750, the device triggers the classifier (e.g., classifier 630) every IP-layer timer cycle to make a decision of whether the call quality is “bad” or “good” based on the MAC-layer and IP-layer features. The second branch then returns to step 720.

In some embodiments, the following IP-layer features are used in the classifier (e.g., classifier 630) to perform video call quality classification:

DLThroughput: this metric can be calculated by: (1) for each link i: multiplying the DL packet count with the DL average packet size (in bits) in the last IP-layer timer cycle with the DL packet frequency; and (2) summing the results from (1) over all links.

ULThroughput: this metric can be calculated by: (1) for each link i: multiplying the UL packet count with the UL average packet size (in bits) in the last IP-layer timer cycle with the UL packet frequency; and (2) summing the results from (1) over all links.

Resource Utilization (RU) Rate 1 (RU₁): This metric can be computed every IP-layer timer cycle as the aggregated IP-layer throughput among all links over the aggregated MAR among all links. It is the ratio of the total throughput (DL Throughput+UL Throughput) to the MAR.

$$R {U}_{1} = \frac{TotalThroughput}{M A R} = \frac{{\sum }_{i ∈ Activated Links} Throughput ( i )}{{\sum }_{i ∈ Activated Links} MAR ( i )} = \frac{DLThroughput + ULThroughput}{M A R}$$

If the RU rate is too large, then the device's channel resource becomes stringent and is prone to have congestion and is indicative of bad video quality. This could indicate that the device should switch to a link configuration with higher bandwidth (e.g., activate an additional helper link, or switch the link channel to another frequency with a higher bandwidth) to ensure the QoS.

On the other hand, if RU rate is too low, the device becomes energy-inefficient as it provides too may extra channel resources compared to the application demand, so it would mean that the video call quality is good. This could indicate that the device should switch to a link configuration with a lower bandwidth (e.g., deactivate other helper links, or switch the link channel to another frequency with a lower bandwidth) to save power.

Resource Utilization (RU) Rate 2 (RU₂): this metric can be calculated as the following ratio:

$$R {U}_{2} = \frac{min ( TotalThroughput , Rqd\_Throughput )}{M A R}$$

Rqd_Throughput is the minimum throughput required for a good quality video call.

In some embodiments, the cycle of MAC-layer timer and the IP-layer timer are variables that can be manually tuned. For example, a smaller timer cycle may provide the device more robust channel condition changes over time and reduce the delay in MLO adaptation. However, if the timer cycle is too small the MAC-layer and IP-layer features may also become inaccurate due to high deviations of the traffic statistics, and the MLO adaptation may become energy-inefficient as chipset reporting for MAC-layer features may have high energy costs.

Although FIG. 7 illustrates one example method for collecting MAC-layer features and IP-layer features 700, various changes may be made to FIG. 7. For example, while shown as a series of steps, various steps in FIG. 7 could overlap, occur in parallel, occur in a different order, occur any number of times, be omitted, or replaced by other steps.

As described above regarding FIG. 7, a device may estimate an MAR for the device's application. In some embodiments, the MAR for the application may be estimated as follows:

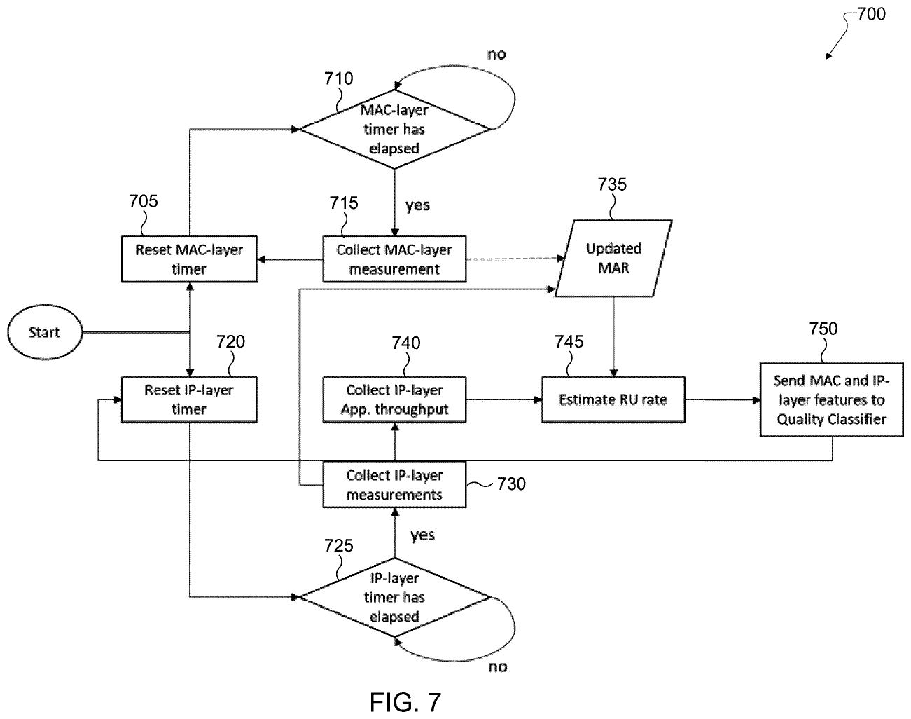

In the examples of FIGS. 6A-6B, any machine learning classifier can be used with the MAC-layer and/or IP-layer features described herein to perform quality classification of calls. In some embodiments, a decision tree is used to perform classification as shown in FIG. 8.

FIG. 8 illustrates an example decision tree for quality classification 800 according to embodiments of the present disclosure. The embodiment of a decision tree of FIG. 8 is for illustration only. One or more of the components illustrated in FIG. 8 may be implemented in specialized circuitry configured to perform the noted functions or one or more of the components may be implemented by one or more processors executing instructions to perform the noted functions. Different embodiments of a decision tree for quality classification could be used without departing from the scope of this disclosure.

In the example of FIG. 8, decision tree 800 begins at decision node 805. At decision node 805, if DLThroughput is greater than a threshold Th_{dlT}_{₁} (e.g., Th_{dlT}_{₁}=1.5), and DLThroughput is less than MAR, and RU₁ is less than or equal to a threshold Th_{RU1} (e.g., Th_{RU1}=50), the decision tree proceeds to leaf node 810 and the classifier outputs the quality as good. Otherwise, the decision tree proceeds to decision node 815.

At decision node 815, if DLThroughput is greater than a threshold Thair, (e.g., Th_{dlT}_{₂}=0.15), the decision tree proceeds to decision node 825. Otherwise, the decision tree proceeds to leaf node 820 and the classifier outputs the quality as bad.

At decision node 825, if RU₂ is less than or equal to a threshold Th_{RU2} (e.g., Th_{RU2}=20), the decision tree proceeds to decision node 830. Otherwise, the decision tree proceeds to decision node 845.

At decision node 830, if DLThroughput is greater than a threshold Th_{dlT}_{₃} (e.g., Th_{dlT}_{₃}=0.4), the decision tree proceeds to leaf node 835 and the classifier outputs the quality as good. Otherwise, the decision tree proceeds to leaf node 840 and the classifier outputs the quality as bad.

At decision node 845, if success_rate is greater than a threshold Th_{dlT}_{₃} (e.g., Thₛᵣ_{₁}=0.85), the decision tree proceeds to leaf node 850 and the classifier outputs the quality as good. Otherwise, the decision tree proceeds to decision node 855.

At decision node 855, if DLThroughput is greater than a threshold Thatry (e.g., Th_{dlT4}=6, the decision tree proceeds to leaf node 860 and the classifier outputs the quality as good. Otherwise, the decision tree proceeds to leaf node 865 and the classifier outputs the quality as bad.

Although FIG. 8 illustrates an example decision tree for quality classification 800, various changes may be made to FIG. 8. For example, various changes to the number and type of link features used to perform quality classification could be made according to particular needs.

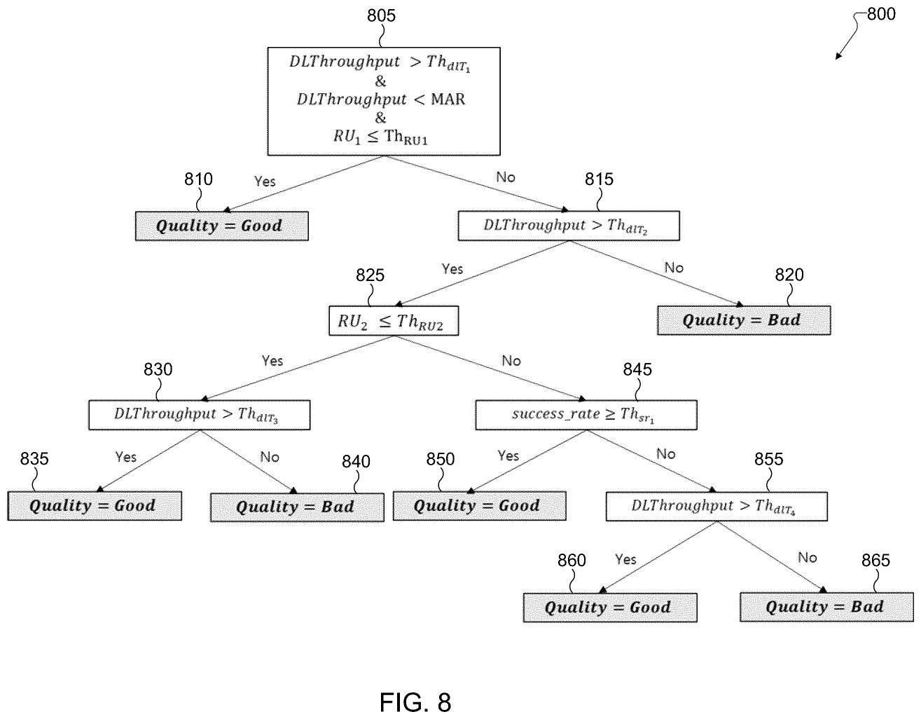

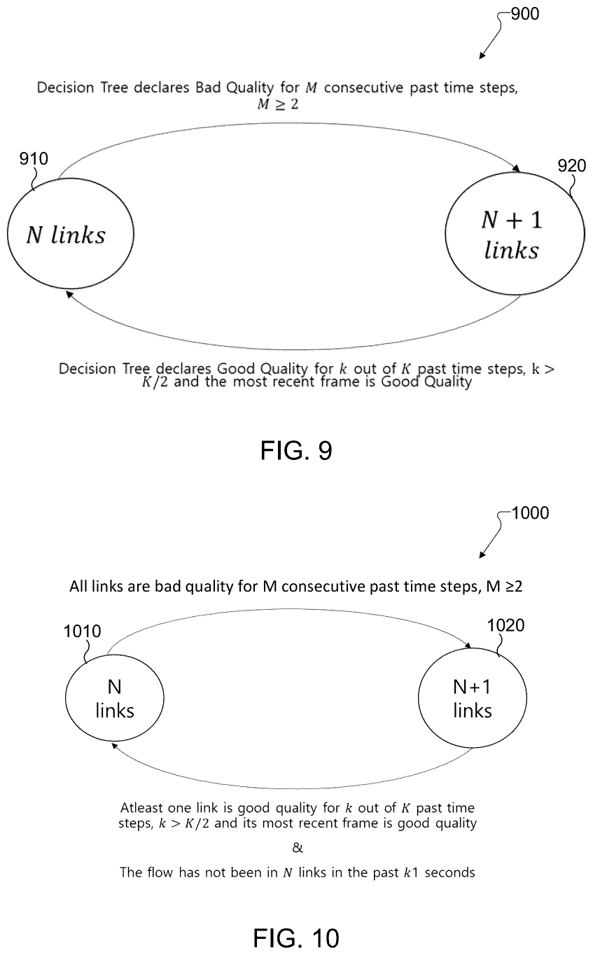

As previously described herein, some embodiments may use a state machine to add/remove links based on the quality classification. Example state machines are shown in FIG. 9 and FIG. 10.

FIG. 9 illustrates an example state machine to add/remove links based on quality classification 900 according to embodiments of the present disclosure. The embodiment of a state machine of FIG. 9 is for illustration only. One or more of the components illustrated in FIG. 9 may be implemented in specialized circuitry configured to perform the noted functions or one or more of the components may be implemented by one or more processors executing instructions to perform the noted functions. Different embodiments of a state machine to add/remove links based on quality classification could be used without departing from the scope of this disclosure.

In the example of FIG. 9, when the classifier declares bad quality for at least a preconfigured number of time steps M, where M is greater than or equal to 2, the state transitions to state 920 where a link is quickly added to a number of links in use N to increase the QoS. By not changing states immediately after the first time step with a bad quality classification, occasional bad quality classification outliers do not trigger the addition of links.

When the classifier declares good quality using the MAC-layer features for the link having a highest use frequency among the N links (the “high frequency link”) for a majority of time steps in a preconfigured past number of time steps K, and the most recent time step is good quality, the state transitions to state 910 where a link that is different from the high frequency link is removed. By only changing states when the majority of the K time steps are good quality avoids dropping a link without the good quality being persistent in the present link configuration. Note that in the example of FIG. 9, when the number of links N=1, the device is operating according to single link operation.

Although FIG. 9 illustrates an example state machine to add/remove links based on quality classification 900, various changes may be made to FIG. 9. For example, various changes to the number states, as well as the transition conditions could be made according to particular needs.

FIG. 10 illustrates another example state machine to add/remove links based on quality classification 1000 according to embodiments of the present disclosure. The embodiment of a state machine of FIG. 10 is for illustration only. One or more of the components illustrated in FIG. 10 may be implemented in specialized circuitry configured to perform the noted functions or one or more of the components may be implemented by one or more processors executing instructions to perform the noted functions. Different embodiments of a state machine to add/remove links based on quality classification could be used without departing from the scope of this disclosure.

In the example of FIG. 10, when in multilink operation, the MAR, RU₁ and RU₂ are individually calculated for each of a number of links in use N. Based on the common IP-layer features, the video call quality based on the individual link features is calculated for each of the N links. Then state machine 1000 is used to determine whether to add or drop a link.

When the classifier declares bad quality for all of the Nlinks for at least a preconfigured number of time steps M, where M is greater than or equal to 2, the state transitions to state 1020 where a link is quickly added to a number of links in use N to increase the QoS. By not changing states immediately after the first time step with bad quality classification for all of the N links, occasional bad quality classification outliers do not trigger the addition of links.

When the classifier declares good quality for at least one of the enabled Nlinks for the majority of a preconfigured past number of time steps K and the flow has not been in N links in a preconfigured past number of seconds k1 (e.g. k1=2), then the state transitions to state 1010 and a link can be dropped. Only changing states when the flow has not been in N links in the past k1 seconds avoids frequent adding and dropping of links. Note that in the example of FIG. 10, when the number of links N=1, the device is operating according to single link operation.

In some embodiments, to avoid frequent adding a dropping of links, state machine 1000 may operate according to the following procedure:
1. If all N links are bad quality for M consecutive past time steps, add a link (i.e., transition to state 1020).
2. If at least one of the links is good quality for k out of K past time steps and the most recent frame is good quality, remove a link, N+1 (i.e., transition to station 1010), only if the flow has not been in N links in a preconfigured past number of seconds k1 (e.g. k1=2).
3. If the conditions in point 2 are satisfied, but the flow has been in N links in the past k1 seconds,
   If the link maintains good quality for a preconfigured number of next seconds k2 (eg. k2=10), make another attempt to drop a link (i.e., transition to station 1010).
   If the time spent in N links after dropping the link is less than some seconds before the conditions to add another link were satisfied, it indicates that N links are not sufficient to support the application. In that case, add a link (i.e., transition to state 1020) and increase the value of k2 (eg. to 12 or 15 seconds).
   If k2 is increased more than twice, the flow remains in N+1 links for the remaining duration without attempting to drop a link again.

Although FIG. 10 illustrates an example state machine to add/remove links based on quality classification 1000, various changes may be made to FIG. 10. For example, various changes to the number states, as well as the transition conditions could be made according to particular needs.

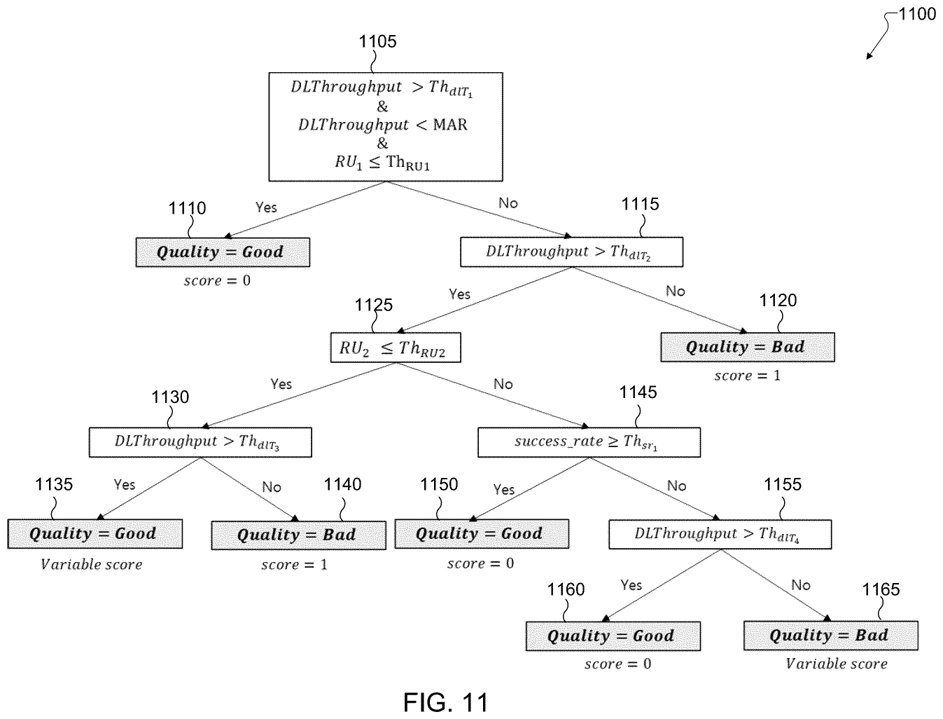

In some embodiments, other machine learning classifiers, for example SVM, random forest, XGBoost, multi-layer perceptron (MLP), convolutional neural network (CNN), etc, can be trained using training data to classify the call quality. In some embodiments, based on a division of training data across different leaf nodes of a decision tree, scores can be assigned to features (e.g., the MAC-layer and/or IP-layer features described herein). For example, the scores could indicate the probability that data belongs to a bad quality of call. For instance, if the score=1, this may indicate that the feature represents a bad quality of call with a 100% confidence. Alternatively, if the score=0, this may indicate good video call quality with 100% confidence. In one embodiment, call quality is classified according to scores based on the decision tree shown in FIG. 11.

FIG. 11 illustrates another example decision tree for quality classification 1100 according to embodiments of the present disclosure. The embodiment of a decision tree of FIG. 11 is for illustration only. One or more of the components illustrated in FIG. 11 may be implemented in specialized circuitry configured to perform the noted functions or one or more of the components may be implemented by one or more processors executing instructions to perform the noted functions. Different embodiments of a decision tree for quality classification could be used without departing from the scope of this disclosure.

In the example of FIG. 8, decision tree 1105 begins at decision node 805. At decision node 805, if DLThroughput is greater than a threshold Thair (e.g., Thair=1.5), and DLThroughput is less than MAR, and RU₁ is less than or equal to a threshold Th_{RU1} (e.g., ThRU1=50), the decision tree proceeds to leaf node 1110 and the classifier outputs a score of 0 (i.e., good video call quality with 100% confidence). Otherwise, the decision tree proceeds to decision node 1115.

At decision node 1115, if DLThroughput is greater than a threshold Th_{dlT2} (e.g., Th_{dlTr2}=0.15), the decision tree proceeds to decision node 1125. Otherwise, the decision tree proceeds to leaf node 1120 and the classifier outputs a score of 1 (i.e., bad video call quality with 100% confidence).

At decision node 1125, if RU₂ is less than or equal to a threshold Th_{RU2} (e.g., Th_{RU2}=20), the decision tree proceeds to decision node 1130. Otherwise, the decision tree proceeds to decision node 1145.

At decision node 1130, if DLThroughput is greater than a threshold ThalT (e.g., Th_{dlT}_{₃}=0.4), the decision tree proceeds to leaf node 1135 and the classifier outputs a variable score between 0 and 1 (e.g., 0.3) based on the distribution of training data across different classes in the leaf nodes. The score represents the probability of the data belonging to a bad quality of call. Otherwise, the decision tree proceeds to leaf node 1140 and the classifier outputs a score of 1.

At decision node 1145, if success_rate is greater than a threshold Thsr (e.g., Thₛᵣ_{₁}=0.85), the decision tree proceeds to leaf node 1150 and the classifier outputs a score of 0. Otherwise, the decision tree proceeds to decision node 1155.

At decision node 1155, if DLThroughput is greater than a threshold ThatTA (e.g., Th_{dlT}_{₄}=6, the decision tree proceeds to leaf node 1160 and the classifier outputs a score of 0. Otherwise, the decision tree proceeds to leaf 1165 and the classifier outputs a variable score between 0 and 1 (e.g., 0.8) based on the distribution of training data across different classes in the leaf nodes. The score represents the probability of the data belonging to a bad quality of call.

Although FIG. 11 illustrates an example decision tree for quality classification 1100, various changes may be made to FIG. 11. For example, various changes to the number and type of link features used to perform quality classification could be made according to particular needs.

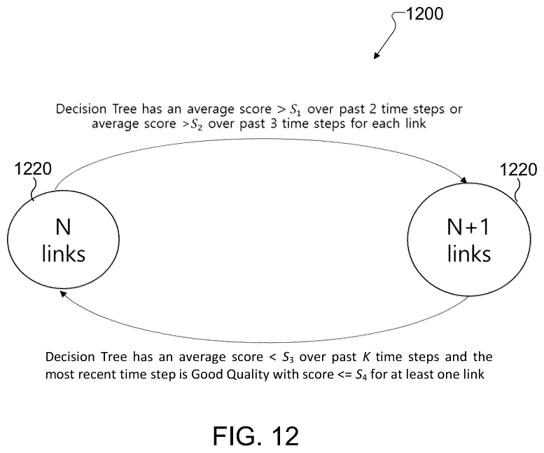

In some embodiments, a state machine such as shown in FIG. 12 is used to add/drop links using score-based quality classification (for example, based on decision tree 1100 of FIG. 11).

FIG. 12 illustrates an example state machine to add/remove links based on score-based quality classification 1200 according to embodiments of the present disclosure. The embodiment of a state machine of FIG. 12 is for illustration only. One or more of the components illustrated in FIG. 12 may be implemented in specialized circuitry configured to perform the noted functions or one or more of the components may be implemented by one or more processors executing instructions to perform the noted functions. Different embodiments of a state machine to add/remove links based on quality classification could be used without departing from the scope of this disclosure.

In the example of FIG. 12, when the decision tree has an average score greater than a threshold S₁ (e.g., S₁=0.75) over the past 2 time steps for each link, or an average score greater than a threshold S₂ (e.g., S₂=0.7) over the past 3 time steps for each link, the state transitions to state 1220 where a link is quickly added to a number of links in use N to increase the QoS. By not changing states after the first time step exceeding the thresholds, occasional bad quality classification outliers do not trigger the addition of links.

When the decision tree has an average score less than a threshold S₃ (e.g., S₃=0.5) over a predetermined number of past time steps K, and the most recent time step is good quality with a score less than or equal to a threshold S₄ (e.g., S_{4=0.25}) for at least one link, the state transitions to state 1210 where a link is removed. Note that in the example of FIG. 12, when the number of links N=1, the device is operating according to single link operation.

Although FIG. 12 illustrates an example state machine to add/remove links based on score-based quality classification 1200, various changes may be made to FIG. 12. For example, various changes to the number states, as well as the transition conditions could be made according to particular needs.

Various embodiments discussed above reflect cases where a link is added or removed. In some embodiments, a link configuration may be changed based on the decision of whether the call quality is “good” or “bad”. Example link configurations that can be changed can include operating bandwidth(s). In some of these embodiments, every time the application throughput is updated, the device computes the Resource Utilization (RU) rate as the updated actual throughput divided by the current version of the MAR. Then the device performs the call quality determination as discussed herein. If the call quality is classified as “bad”, then device can change to a link configuration with more bandwidth too avoid congestion and preserve the QoS. If the call quality is classified as “good”, the device can change to a link configuration with less bandwidth to save power. Otherwise, the device can remain its current link configuration. In some embodiments, the link adaptation is triggered every cycle of an IP-layer timer cycle. As an alternative to the above embodiments, various embodiments of the present disclosure may adapt the data rate based as described below.

In the some embodiments, instead of adapting according to the data rate, which is constrained by both the nature of application and the channel resources (e.g., in real-time traffic congestion control, the target bit rate is the minimum of maximum achievable transmission rate of the application, and the maximum achievable receiving rate that is largely determined by channel resource conditions), the device has the extra capability to adapt its link configuration to remove itself from the constraints of the channel resources. Therefore, WiFi-7 with dynamic adaptation over its MLO configuration can improve QoS performance under busy channel scenarios, as the congestion control is more focused on adding more channel resources instead of reducing the application data rate. On the other hand, dynamic adaptation of WiFi-7 MLO can also remain energy-efficient as the device can save the underutilized channel resources when traffic is light.

For example, the general setup of MLO where the device can operate on 2.4 GHz, 5 GHz, and 6 GHz with the set of all MLO configurations (also referred to as states) is provided as shown, for example, below (in a descending order of total bandwidth/power consumption) in Table 1:

TABLE 1

| State Definition (Bandwidth) | Power Consumption Score |
|---|---|
| 6 GHz (160 MHz) + 2.4 GHz (20 MHz) | 5 |
| 6 GHz (160 MHz) | 4 |
| 5 GHz (80 MHz) + 2.4 GHz (20 MHz) | 3 |
| 5 GHz (80 MHz) | 2 |
| 2.4 GHz (20 MHz) | 1 |

In some embodiments, the device adapts its MLO state every IP-layer timer cycle in a stepwise manner by switching to the MLO state adjacent to the current state in Table 1 (e.g., with a current MLO state being 5 GHz, the device can only switch its MLO state to 5 GHz+2.4 GHz or 2.4 GHz). In some embodiments, the devices use the RU rate metric introduced herein as the threshold triggering the adaptation of the MLO state. However, the adjacent state switching, is not mandatory, and some embodiments may switch from one state to another state which is not adjacent in the Table 1.

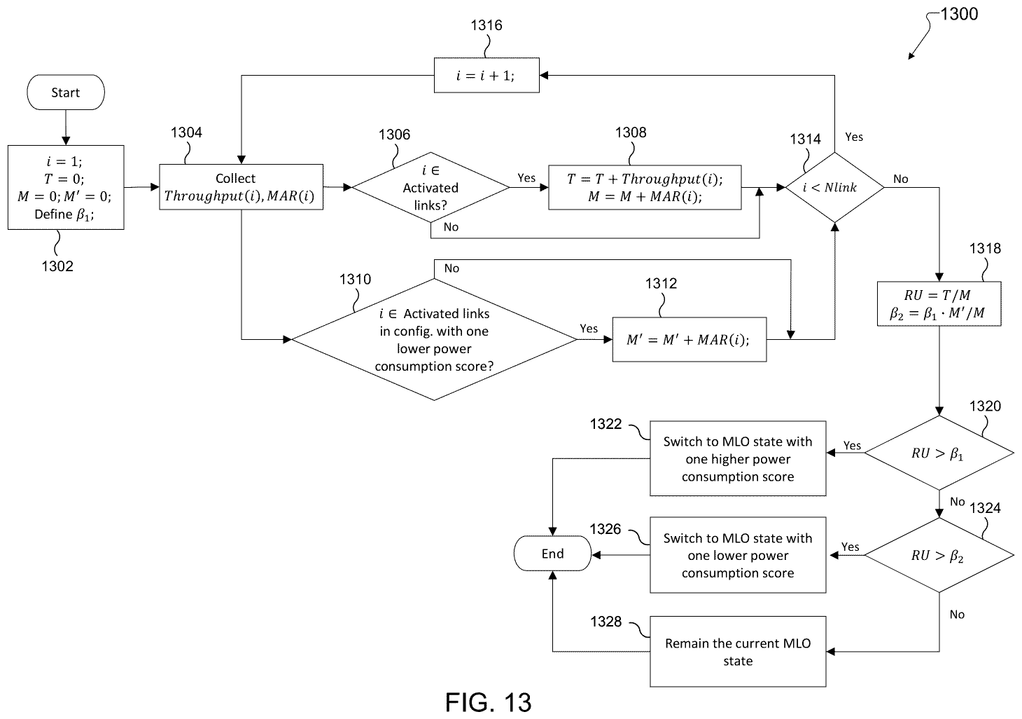

In some embodiments, a control algorithm for dynamic MLO adaptation may be based on Hysteresis thresholding, where two threshold values (β₁ and β₂, with β₁>β₂) are compared with the computed RU rate, resulting in three decision spaces: (1) the RU rate is greater than β₁ and the device switches to the link configuration state with one higher power consumption score in the Table 1; (2) the RU rate is less than β₂ and the device switches to the link configuration state with one less power consumption score in Table 1; and (3) the RU rate less than $1 and greater than β₂ and the device maintains the current link configuration state. One embodiment of a control algorithm according to the above is shown in FIG. 13.

FIG. 13 illustrates an example method for hysteresis thresholding based dynamic MLO adaptation 1300 according to embodiments of the present disclosure. An embodiment of the method illustrated in FIG. 1300 is for illustration only. One or more of the components illustrated in FIG. 1300 may be implemented in specialized circuitry configured to perform the noted functions or one or more of the components may be implemented by one or more processors executing instructions to perform the noted functions. Other embodiments for hysteresis thresholding based dynamic MLO adaptation could be used without departing from the scope of this disclosure.

In the example of FIG. 13, method 1300 begins at step 1302. At step 1302, a device such as non-AP MLD 302 of FIG. 3 sets a variable i equal to 1, and sets variables T, M, and M′ equal to 0. The variable i corresponds with a link number. The variable T corresponds with the aggregated throughput of the set of activated links. The variable M corresponds with an aggregated MAR of the set of activated links. The variable M′ corresponds with an aggregated MAR of the set of activated links in the MLO configuration with one lower power consumption score than the present MLO configuration (i.e., the configuration where the device may be switched to for power saving).

Additionally, at step 1302 an MLO adaptation threshold β₁ is defined. The MLO adaptation threshold β₁ is an application-specific variable that implies how sensitive the application is towards congestions. In some embodiments, MLO adaptation threshold β₁ can be learned via QoS evaluations of the application traffic.

At step 1304, the device collects the throughput and MAR for a link i (Throughput(i), MAR(i)). After the collection, the method proceeds concurrently in two parallel branches. The first branch begins at step 1306, and the second branch begins step 1310.

At step 1306, the device determines whether the link i belongs to the set of activated links. If the link i belongs to the set of activated links, the first branch proceeds to step 1308. Otherwise, the first branch proceeds to step 1314 where the first branch converges with the second branch.

At step 1308, the device increases T by an amount equal to the throughput collected at step 1304, and the device also increases M by an amount equal to the MAR collected at step 1304. The first branch then proceeds to step 1314 where it converges with the second branch.

At step 1310, the devices determines whether link i belongs to the set of activated links in the MLO configuration with one lower power consumption score than the present MLO configuration. If link i belongs to the set of activated links in the set of activated links in the MLO configuration with one lower power consumption score than the present MLO configuration, the second branch proceeds to step 1312. Otherwise, the second branch proceeds to step 1314 where the second branch converges with the first branch.

At step 1312, the device increases M′ by an amount equal to the MAR collected at step 1304. The second branch then proceeds to step 1314 where it converges with the first branch.

At step 1314, the device determines whether link number i is less than the number of total possible links the device can connect to (Nlink). If so, the method proceeds to step 1318. Otherwise, the method proceeds to step 1316.

At step 1316, variable i is incremented by one, and the method returns to step 1304.

At step 1318, the device calculates the RU rate (RU) as the aggregated throughput of the activated links (T) divided by the aggregated MAR of the activated links (M).

Additionally, at step 1318, the device sets an MLO adaptation threshold β₂. MLO adaptation threshold β₂ is dynamic to channel condition, and β₂ is selected as the largest possible value where the updated RU rate will not exceed β₁ while the device switches to a link configuration with lower bandwidth, such that the device can save maximum amount of power while ensuring the QoS. Because the configuration with less power consumption score has less bandwidth, M′ is less than M and, the updated RU rate will be larger. Therefore, β₂ is set such that the updated RU rate still smaller than β₁ to avoid congestion and control ping-pong effect:

$$\frac{{T}_{max}}{{M}^{′}} \leq {β}_{1} , where \frac{{T}_{max}}{M} = {β}_{2}$$

### Therefore, β₂ is set as:

$${β}_{2} = \frac{{M}^{′}}{M} \cdot {β}_{1}$$

At step 1320, the device determines whether the RU rate is greater than β₁. If the RU rate is greater than 81, the method proceeds to step 1322. Otherwise, the method proceeds to step 1324.

At step 1322, the device switches to the MLO configuration with one higher power consumption score than the present MLO configuration.

At step 1324, the device determines whether the RU rate is less than β₂. If the RU rate is less than β₂, the method proceeds to step 1326. Otherwise, the method proceeds to step 1328.

At step 1326, the device switches to the MLO configuration with one lower power consumption score than the present MLO configuration.

At step 1328, the device maintains the current MLO configuration.

Although FIG. 13 illustrates one example method for hysteresis thresholding based dynamic MLO adaptation 1300, various changes may be made to FIG. 13. For example, while shown as a series of steps, various steps in FIG. 13 could overlap, occur in parallel, occur in a different order, occur any number of times, be omitted, or replaced by other steps.

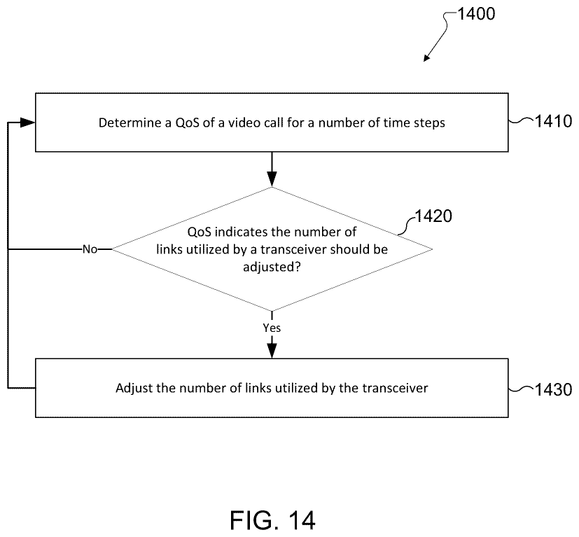

FIG. 14 illustrates an example method for multi-link adaptation based on network quality monitoring 1400 according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a method for multi-link adaptation based on network quality monitoring could be used without departing from the scope of this disclosure.

In the Example of FIG. 14, method 1400 begins at step 1410. At step 1410, a device such as non-AP MLD 302 of FIG. 3 determines a QoS of a video call for a number of time steps.

In some embodiments, the device may classify the quality of the video call based on at least one MAC layer feature and at least one IP layer feature. In some embodiments, the QoS of the video call may be determined based on the classification. In some embodiments, the device may estimate, based on the at least one MAC layer feature and the at least one IP layer feature, a MAR. In some embodiments, the device may estimate, based on the at least one IP layer feature, an RU rate. In some embodiments, the quality of the video call may be classified based on the RU and the MAR.

In some embodiments, the device may classify the quality of the video call, according to a decision tree, based on at least one medium access control (MAC) layer feature. In some embodiments, the QoS of the video call may be determined based on the classification.

At step 1420, the device determines based on the QoS of the video call over the number of time steps, whether to adjust a number of links utilized by a transceiver configured to adapt between SLO and MLO operation. If the device determines to adjust the number of links, the method proceeds to step 1430. Otherwise, the method returns to step 1410.

In some embodiments, for each time step, the determination of the QoS of the video call may include an evaluation for each link utilized by the transceiver of one of good or bad. In some embodiments, when the evaluation for each link utilized by the transceiver is bad for a number of consecutive time steps exceeding a first threshold, the device may determine to increase the number of links utilized by the transceiver. In some embodiments, when the evaluation for at least one link utilized by the transceiver is good for a latest time step and a number of previous time steps exceeding a second threshold, and a flow of the video call has not been in at least one less link than the number of links utilized by the transceiver in a number of previous time steps exceeding a third threshold, the device may determine to decrease the number of links utilized by the transceiver.

In some embodiments, the determination of the QoS of the video call may include, for each link utilized by the transceiver, a score determined from a decision tree. In some embodiments, when an average score of all the links over a number of previous time steps exceeds a first threshold, the device may determine to increase the number of links utilized by the transceiver. In some embodiments, when an average score of all the links utilized by the transceiver over another number of previous time steps exceeds a second threshold, the device may determine to increase the number of links utilized by the transceiver. In some embodiments, when an average score of all the links over a number of previous time steps falls below a third threshold and a most recent score for at least one link utilized by the transceiver falls below a fourth threshold, the device may determine to decrease the number of links utilized by the transceiver.

At step 1430, the device adjusts the number of links utilized by the transceiver, and the method returns to step 1410.

Although FIG. 14 illustrates one example method for multi-link adaptation based on network quality monitoring 1400, various changes may be made to FIG. 14. For example, while shown as a series of steps, various steps in FIG. 14 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. An electronic device comprising:
a transceiver configured to adapt between single-link operation (SLO) and multi-link (MLO) operation; and
a processor operably coupled to the transceiver, configured to:
determine a quality of service (QOS) of a video call for a number of time steps;
determine, based on the QoS of the video call over the number of time steps, whether to adjust a number of links utilized by the transceiver; and
in response to a determination to adjust the number of links, adjust the number of links utilized by the transceiver.

2. The electronic device of claim 1, wherein to determine the QoS of the video call, the processor is further configured to:
classify the quality of the video call based on at least one medium access control (MAC) layer feature and at least one internet protocol (IP) layer feature; and
determine the QoS of the video call based on the classification.

3. The electronic device of claim 2, wherein to classify the quality of the video call based on at least one MAC layer feature and the at least one IP layer feature, the processor is further configured to:
estimate, based on the at least one MAC layer feature and the at least one IP layer feature, a maximum achievable rate (MAR.

4. The electronic device of claim 3, wherein to classify the quality of the video call based on the least one MAC layer feature and the at least one IP layer feature, the processor is further configured to:
estimate, based on the at least one IP layer feature, a resource utilization (RU) rate; and
classify the quality of the video call based on the RU and the MAR.

5. The electronic device of claim 1, wherein:
for each time step, the determination of the QoS of the video call includes an evaluation for each link utilized by the transceiver of one of good or bad; and
the processor is further configured to:
when the evaluation for each link utilized by the transceiver is bad for a number of consecutive time steps exceeding a first threshold, determine to increase the number of links utilized by the transceiver; and
when the evaluation for at least one link utilized by the transceiver is good for a latest time step and a number of previous time steps exceeding a second threshold, and a flow of the video call has not been in at least one less link than the number of links utilized by the transceiver in a number of previous time steps exceeding a third threshold, determine to decrease the number of links utilized by the transceiver.

6. The electronic device of claim 1, wherein:
for each time step, the determination of the QoS of the video call includes, for each link utilized by the transceiver, a score determined from a decision tree; and
the processor is further configured to:
when an average score of all the links over a number of previous time steps exceeds a first threshold, determine to increase the number of links utilized by the transceiver;
when an average score of all the links utilized by the transceiver over another number of previous time steps exceeds a second threshold, determine to increase the number of links utilized by the transceiver; and
when an average score of all the links over a number of previous time steps falls below a third threshold and a most recent score for at least one link utilized by the transceiver falls below a fourth threshold, determine to decrease the number of links utilized by the transceiver.

7. The electronic device of claim 1, wherein to determine the QoS of the video call, the processor is further configured to:
classify the quality of the video call, according to a decision tree, based on at least one medium access control (MAC) layer feature; and
determine the QoS of the video call based on the classification.

8. A method of operating an electronic device, the method comprising:
determining a quality of service (QOS) of a video call for a number of time steps;
determining, based on the QoS of the video call over the number of time steps, whether to adjust a number of links utilized by a transceiver configured to adapt between single-link operation (SLO) and multi-link (MLO) operation; and
in response to a determination to adjust the number of links, adjusting the number of links utilized by the transceiver.

9. The method of claim 8, further comprising classifying the quality of the video call based on at least one medium access control (MAC) layer feature and at least one internet protocol (IP) layer feature,
wherein the QoS of the video call is determined based on the classification.

10. The method of claim 9, further comprising estimating, based on the at least one MAC layer feature and the at least one IP layer feature, a maximum achievable rate (MAR).

11. The method of claim 10, further comprising estimating, based on the at least one IP layer feature, a resource utilization (RU) rate,
wherein the quality of the video call is classified based on the RU and the MAR.

12. The method of claim 8, wherein:
for each time step, the determination of the QoS of the video call includes an evaluation for each link utilized by the transceiver of one of good or bad; and
the method further comprises:
when the evaluation for each link utilized by the transceiver is bad for a number of consecutive time steps exceeding a first threshold, determining to increase the number of links utilized by the transceiver; and
when the evaluation for at least one link utilized by the transceiver is good for a latest time step and a number of previous time steps exceeding a second threshold, and a flow of the video call has not been in at least one less link than the number of links utilized by the transceiver in a number of previous time steps exceeding a third threshold, determining to decrease the number of links utilized by the transceiver.

13. The electronic device of claim 8, wherein:
for each time step, the determination of the QoS of the video call includes, for each link utilized by the transceiver, a score determined from a decision tree; and
the method further comprises:
when an average score of all the links over a number of previous time steps exceeds a first threshold, determining to increase the number of links utilized by the transceiver;
when an average score of all the links utilized by the transceiver over another number of previous time steps exceeds a second threshold, determining to increase the number of links utilized by the transceiver; and
when an average score of all the links over a number of previous time steps falls below a third threshold and a most recent score for at least one link utilized by the transceiver falls below a fourth threshold, determining to decrease the number of links utilized by the transceiver.

14. The method of claim 8, further comprising classifying the quality of the video call, according to a decision tree, based on at least one medium access control (MAC) layer feature,
wherein the QoS of the video call is determined based on the classification.

15. A non-transitory computer readable medium embodying a computer program, the computer program comprising program code that, when executed by a processor of a device, causes the device to:
determine a quality of service (QOS) of a video call for a number of time steps;
determine, based on the QoS of the video call over the number of time steps, whether to adjust a number of links utilized by a transceiver configured to adapt between single-link operation (SLO) and multi-link (MLO) operation; and
in response to a determination to adjust the number of links, adjust the number of links utilized by the transceiver.

16. The non-transitory computer readable medium of claim 15, wherein to determine the QoS of the video call, the program code, when executed by the processor of the device, further causes the device to:
classify the quality of the video call based on at least one medium access control (MAC) layer feature and at least one internet protocol (IP) layer feature; and
determine the QoS of the video call based on the classification.

17. The non-transitory computer readable medium of claim 16, wherein to classify the quality of the video call based on at least one MAC layer feature and the at least one IP layer feature, the program code, when executed by the processor of the device, further causes the device to:
estimate, based on the at least one MAC layer feature and the at least one IP layer feature, a maximum achievable rate (MAR);
estimate, based on the at least one IP layer feature, a resource utilization (RU) rate; and
classify the quality of the video call based on the RU and the MAR.

18. The non-transitory computer readable medium of claim 15, wherein:
for each time step, the determination of the QoS of the video call includes an evaluation for each link utilized by the transceiver of one of good or bad; and
the program code, when executed by the processor of the device, further causes the device to:
when the evaluation for each link utilized by the transceiver is bad for a number of consecutive time steps exceeding a first threshold, determine to increase the number of links utilized by the transceiver; and
when the evaluation for at least one link utilized by the transceiver is good for a latest time step and a number of previous time steps exceeding a second threshold, and a flow of the video call has not been in at least one less link than the number of links utilized by the transceiver in a number of previous time steps exceeding a third threshold, determine to decrease the number of links utilized by the transceiver.

19. The non-transitory computer readable medium of claim 15, wherein:
for each time step, the determination of the QoS of the video call includes, for each link utilized by the transceiver, a score determined from a decision tree; and
the program code, when executed by the processor of the device, further causes the device to:
when an average score of all the links over a number of previous time steps exceeds a first threshold, determine to increase the number of links utilized by the transceiver;
when an average score of all the links utilized by the transceiver over another number of previous time steps exceeds a second threshold, determine to increase the number of links utilized by the transceiver; and
when an average score of all the links over a number of previous time steps falls below a third threshold and a most recent score for at least one link utilized by the transceiver falls below a fourth threshold, determine to decrease the number of links utilized by the transceiver.

20. The non-transitory computer readable medium of claim 15, wherein to determine the QoS of the video call, the program code, when executed by the processor of the device, further causes the device to:
classify the quality of the video call, according to a decision tree, based on at least one medium access control (MAC) layer feature; and
determine the QoS of the video call based on the classification.
